(19) United States
(12) Patent Application Publication
(10) Pub. No.: US 2026/0356462 A1
(43) Pub. Date: Nov. 12, 2026

(54) AQUATIC LAUNCHING ASSEMBLY FOR MOBILE PLATFORMS

(71) Applicant: Perennial Autonomy, LLC, Menlo Park, CA (US)

(72) Inventor: Christian Johan Owen HANDLEY, San Francisco, CA (US)

(21) Appl. No.: 19/672,531

(22) Filed: May 8, 2026

Related U.S. Application Data
(63) Continuation-in-part of application No. 19/542,624, filed on Feb. 17, 2026.
(60) Provisional application No. 63/960,687, filed on Jan. 14, 2026.
(60) Provisional application No. 63/910,760, filed on Nov. 3, 2025.
(60) Provisional application No. 63/854,392, filed on Jul. 30, 2025.
(60) Provisional application No. 63/815,810, filed on Jun. 1, 2025.
(60) Provisional application No. 63/807,413, filed on May 16, 2025.
(60) Provisional application No. 63/803,081, filed on May 9, 2025.

(51) Int. Cl. B63B 35/50; B64U 70/50; B64U 70/93

(52) U.S. Cl. CPC B63B 35/50; B64U 70/50; B64U 70/93

(57) ABSTRACT

An aquatic launching container assembly includes a stack of at least two mobile platforms and a container. The container includes a body that is configured to be held by an aquatic platform. The body of the container extends a length from a first end to a second end. The body includes an interior compartment that is configured to hold the stack of mobile platforms therein. The first end of the body includes an exit opening. The body is configured to be held by the aquatic platform such that the mobile platforms are configured to be launched from the aquatic platform through the exit opening of the container body.

### CROSS-REFERENCE TO RELATED APPLICATIONS

This non-provisional utility application claims priority to provisional patent application number 63/815,810, entitled “LAUNCHING CONTAINER ASSEMBLY FOR MOBILE PLATFORMS” and filed on Jun. 1, 2025, provisional patent application number 63/807,413, entitled “LAUNCHING CONTAINER USING SUPPORTS FOR MOBILE PLATFORMS” and filed on May 16, 2025, provisional patent application number 63/803,081, entitled “MOBILE PLATFORM DEPLOYMENT METHOD AND SYSTEM” and filed on May 9, 2025, provisional patent application number 63/854,392, entitled “DUAL-PURPOSE BOOT AND METHOD OF MANUFACTURE” and filed on Jul. 30, 2025, provisional patent application number 63/960,687, entitled “CONTAINER ASSEMBLY WITH SECURING MECHANISM” and filed on Jan. 14, 2026, provisional patent application number 63/910,760, entitled “MOBILE PLATFORM STACKING ASSEMBLY” and filed on Nov. 3, 2025, non-provisional patent application number 19/542,624, entitled “STACKING SPACER FOR MOBILE PLATFORMS” and filed on Feb. 17, 2026, each of which is incorporated herein in its entirety by reference.

### BACKGROUND

Existing methods and systems for deploying mobile platforms (e.g., rotor craft, fixed-wing, other uncrewed and/or autonomous aircraft, etc.) exhibit a variety of technical disadvantages.

### SUMMARY

In an aspect, an aquatic launching container assembly includes a stack of at least two mobile platforms and a container. The container includes a body that is configured to be held by an aquatic platform. The body of the container extends a length from a first end to a second end. The body includes an interior compartment that is configured to hold the stack of mobile platforms therein. The first end of the body includes an exit opening. The body is configured to be held by the aquatic platform such that the mobile platforms are configured to be launched from the aquatic platform through the exit opening of the container body.

In another aspect, an aquatic platform includes a stack of at least two mobile platforms and an enclosure. The enclosure includes an interior compartment that is configured to hold the stack of mobile platforms therein. The enclosure includes a door that includes a closed position and an open position. The door is configured to move from the closed position to the open position to enable the stack of mobile platforms to at least one of exit the interior compartment of the enclosure through the door for launch from a deck of the aquatic platform, or launch through the door from within the interior compartment.

In another aspect, a method includes installing a stack of at least two mobile platforms on an aquatic platform, and launching the mobile platforms from the aquatic platform while the aquatic platform operates along a body of water.

### BRIEF DESCRIPTION OF THE DRAWINGS

FIG. 1 is an isometric view illustrating an aquatic platform according to an implementation.

FIG. 2 is an elevational schematic view of an aquatic platform according to an implementation.

FIG. 3 is an elevational schematic view of an aquatic platform according to an implementation.

FIG. 4 is an elevational schematic view of an aquatic platform according to an implementation.

FIG. 5 is an elevational schematic view illustrating a launching system according to an implementation.

FIG. 6 illustrates plan schematic views of launching systems according to implementations.

FIG. 7 illustrates elevational schematic views of launching systems according to implementations.

FIG. 8 is an elevational schematic view illustrating a launching container assembly according to an implementation.

FIG. 9 is a flowchart illustrating a method according to an implementation.

FIG. 10 is a schematic diagram illustrating an example operating environment of the disclosure according to an implementation.

### DETAILED DESCRIPTION

Existing methods and systems for deploying mobile platforms (e.g., rotor craft, fixed-wing, other uncrewed and/or autonomous aircraft, etc.) exhibit a variety of technical disadvantages. For example, deployment of mobile platforms may present various challenges associated with scalability, speed of deployment, compatibility with existing infrastructure, and adaptability, for example across different environments, environmental conditions, and/or operational parameters. In one example, known mobile platform deployment systems have limited ability to operate in aquatic environments (e.g., marine environments, freshwater environments, non-water liquid environments, etc.). In one example, known mobile platform deployment systems rely on fixed bases or portable single-unit launching systems, which lack scalability and have limited deployment speed and application in aquatic environments.

In contrast, aspects of the disclosure integrate mobile platform launching systems into aquatic platforms, for example providing more rapid, large-scale deployment of mobile platforms from aquatic environments. The integration of mobile platform launching systems into aquatic platforms addresses challenges faced by existing systems by, for example, utilizing available aquatic logistics networks and infrastructure. Aspects of the disclosure provide a technical solution that offers the technical effects of enhanced transportation, improved integration with current aquatic logistical chains, and improved deployment capabilities, for example in aquatic environments and aquatic adjacent environments (e.g., locations that are nearby a body of water, etc.). Aspects of the disclosure pertain to an enclosure (e.g., container, etc.) system designed to deploy a greater number of mobile platforms more rapidly, leveraging aquatic platforms as mobile launch platforms. The integration of mobile platform launching systems into aquatic platforms (e.g., boats, ships, submersibles, other water going vessels, etc.) as disclosed herein facilitates compatibility with existing aquatic transportation and logistical systems.

Aspects of the disclosure include a container that is configured to hold the stack of mobile platforms therein. In some examples, the container is configured to be held by the aquatic platform, for example on a deck and/or within an enclosure of the aquatic platform. In some other examples, the container is an internal enclosure of the aquatic platform. For example, a body of the container may be defined by one or more internal structures (e.g., walls, floors, ceilings, etc.) of the aquatic platform that form (e.g., bound, define, etc.) an interior compartment of the aquatic platform.

The mobile platforms can be launched from the aquatic platform through an exit opening of the container, for example from the deck and/or from within the enclosure. Optionally, the container includes a top (e.g., roof, a hatch, a cover, a lid, a door, etc.) that is configured to open, for example manually and/or automatically, to enable faster deployment of a group of mobile platforms, and/or the like. The container is, in some examples, configured for use in one or more aquatic environments. For example, the container may be configured for use in marine and/or freshwater environments by being configured to withstand (e.g., be resistant to, be durable against, etc.) corrosion, pressure, and/or fatigue (e.g., from wave conditions, sea conditions, swell conditions, wind conditions, corrosion, etc.). In some examples, the container includes one or more corrosion-resistant materials, an ingress protection (IP) rating of IP67, IP68, and/or IP69, a crack tip opening displacement (CTOD) score of at least approximately 0.15mm, and/or the like.

Aspects of the disclosure provide a more versatile, scalable, and efficient solution for mobile platform deployment from aquatic environments. For example, the use of an aquatic platform as the basis of a launch platform as disclosed herein enables any standard aquatic processing and logistics infrastructure to store, handle, transport, and support the mobile platform launching systems disclosed herein. In some examples, launching systems disclosed herein makes use of the extensive and cost effective global civilian aquatic supply chains.

Examples of applications of the subject matter disclosed herein include, but are not limited to, community monitoring, disaster response and/or recovery, environmental monitoring, commercial applications, military applications, and/or the like.

Examples of community monitoring applications include deploying mobile platforms from aquatic environments for tasks such as crowd monitoring, search and rescue operations, area surveillance, and/or the like. The methods, systems, and assemblies disclosed herein enhance the ability to manage relatively large-scale events and/or emergency situations by providing more rapid aerial deployment capabilities via bodies of water while minimizing the necessity for extensive on-ground personnel.

Examples of commercial applications include deploying mobile platforms from aquatic environments for fleet-based operations in agriculture, infrastructure inspection, logistics delivery services, and/or the like. The methods, systems, and assemblies disclosed herein enable entities to position mobile platform deployment stations strategically, for example offering adaptive solutions for reaching remote and/or difficult-to-access locations via bodies of water.

In disaster response scenarios, applications include launching mobile platforms from aquatic platforms for real-time damage assessment and/or to assist in coordinating rescue efforts. Mobile platforms can be more quickly deployed via bodies of water to survey affected areas, for example providing critical data to first responders and aiding in the efficient allocation of resources.

In some environmental monitoring examples, environmental monitoring agencies may employ the methods and assemblies disclosed herein to more swiftly deploy mobile platforms from aquatic environments for data collection and/or monitoring activities, such as wildlife tracking, pollution assessment, and/or the like. The mobility of the aquatic platform along waterways grants unparalleled access to diverse environments, for example enabling vital data to be gathered from multiple sites with fewer logistical constraints.

Aspects of the disclosure operate in an unconventional manner at least by providing an aquatic launching container assembly that includes a stack of at least two mobile platforms and a container. The container includes a body that is configured to be held by an aquatic platform. The body of the container extends a length from a first end to a second end. The body includes an interior compartment that is configured to hold the stack of mobile platforms therein. The first end of the body includes an exit opening. The body is configured to be held by the aquatic platform such that the mobile platforms are configured to be launched from the aquatic platform through the exit opening of the container body.

Aspects of the disclosure operate in an unconventional manner at least by providing an aquatic platform that includes a stack of at least two mobile platforms and an enclosure. The enclosure includes an interior compartment that is configured to hold the stack of mobile platforms therein. The enclosure includes a door that includes a closed position and an open position. The door is configured to move from the closed position to the open position to enable the stack of mobile platforms to at least one of exit the interior compartment of the enclosure through the door for launch from a deck of the aquatic platform, or launch through the door from within the interior compartment.

Aspects of the disclosure operate in an unconventional manner at least by providing a method that includes installing a stack of at least two mobile platforms on an aquatic platform, and launching the mobile platforms from the aquatic platform while the aquatic platform operates along a body of water.

Example technical solutions to the technical problems described herein include the utilization of aquatic platforms as adaptable launch platforms, which provides the technical effects of more rapid, large-scale deployment of mobile platforms from aquatic environments. Aspects of the disclosure provide a technical solution that offers the technical effect of enhanced transportation of mobile platforms for deployment, for example utilizing available aquatic logistics networks and infrastructure. For example, the technical solution of deploying mobile platforms from aquatic platforms can leverage widely available (e.g., existing, etc.) aquatic infrastructure and logistics resources to provide the technical effect of enabling scalable, more rapid deployment capabilities, for example utilizing standardized aquatic transportation methods for deployment over relatively wide geographic areas. In some examples, this technical solution provides the technical effect of improved integration with current aquatic logistical chains, and improved deployment capabilities, for example in aquatic environments and adjacent environments that are nearby a body of water.

Aspects of the disclosure provide the technical solution of a container that holds one or more stacks of mobile platforms therein, for example on a deck and/or within an enclosure of the aquatic platform. Aspects of the disclosure provide the technical solution of providing the container with an openable top, or roof, of the container (e.g., partial and/or full opening, etc.) provides the technical effect of improving deployment speed and reducing preparation time upon arrival.

Aspects of the disclosure provide the technical solution of environmental adaptation to aquatic platforms and environments, for example providing the technical effect of facilitating operational reliability under aquatic conditions, adverse conditions, and/or the like. For example, the methods and assemblies disclosed herein provide the technical solution of reinforcement against aquatic environmental influences, for example enabling the technical effect of being capable of operating in marine and/or freshwater environments by being configured to withstand (e.g., be resistant to, be durable against, etc.) corrosion, pressure, and/or fatigue (e.g., from wave, sea, wind, and/or swell conditions, etc.). For example, the container may include the technical solutions of the container including one or more corrosion-resistant materials, an ingress protection (IP) rating of IP67, IP68, and/or IP69, a crack tip opening displacement (CTOD) score of at least approximately 0.15mm, and/or the like. Increased reliability and operational readiness (e.g., through aquatic environmental adaptation) is a technical effect of the disclosure.

Another example of a technical effect of the disclosure includes the reduction of manual labor and potential for human error, for example via remote and/or automated functionalities that, for example, improve safety and operational efficiency.

As described herein, the launching systems disclosed herein are configured for use onboard an aquatic platform, such as, but not limited to, a mobile aquatic platform, a stationary aquatic platform, and/or the like. In some examples, one or more of the launching systems disclosed herein is used with (e.g., onboard, onboard control, remote from, remote control, etc.) one or more uncrewed, autonomous aquatic platforms. As used herein, one or more of the launching systems disclosed herein may be used onboard a mobile aquatic platform while the mobile aquatic platform is moving and/or while the mobile aquatic platform is stationary.

As used herein, an aquatic platform may include any stationary or mobile platform that is configured to operate in an aquatic environment (e.g., marine environments, freshwater environments, non-water liquid environments, etc.), such as, but is not limited to, boats, ships, marine vehicles, freshwater vehicles, surface vehicles, submersibles, uncrewed aquatic vehicles, uncrewed marine vehicles (UMVs), uncrewed surface and/or submersible vehicles (USVs), ocean going vessels, other water going vessels, non-water liquid going vessels, shipping vehicles (e.g., container vessels, vessels configured to carry standard International Organization for Standardization (ISO) shipping containers, etc.), cranes, aquatic stations, aquatic arrays, aquatic central controls, aquatic centralized control stations, towers, cellular towers, wind turbines, a fixed aquatic structure, uncrewed stationary platforms, autonomous stationary platforms, buildings, emplacements, installations, offshore structures, oil and/or natural gas platforms, forts, prisons, government locations, aquatic infrastructure, dams, bridges, and/or the like.

Examples of mobile platforms (e.g., mobile platforms 106, etc.) include, but are not limited to, uncrewed vehicles, uncrewed aerial vehicles (UAVs), aircraft (e.g., rotorcraft, fixed wing aircraft, airplanes, gliders, lighter-than-air craft, balloons, high-altitude balloons, UAVs, etc.), ground vehicles (e.g., land vehicles, automobiles, trucks, cars, electric vehicles, forklifts, golf carts, etc.), uncrewed ground vehicles (UGVs), aquatic vehicles (e.g., boats, ships, marine vehicles, freshwater vehicles, cranes, offshore structures, etc.), surface vehicles, submersibles, uncrewed aquatic vehicles, uncrewed marine vehicles (UMVs), uncrewed surface and/or submersible vehicles (USVs), space-based platforms (e.g., cubesats, etc.), suborbital vehicles, vehicles that operate in orbit, platforms carried by an individual (e.g., a backpack and/or other carrying pack, etc.), missiles, rockets, projectiles, munitions, uncrewed mobile platforms, autonomous mobile platforms, and/or the like.

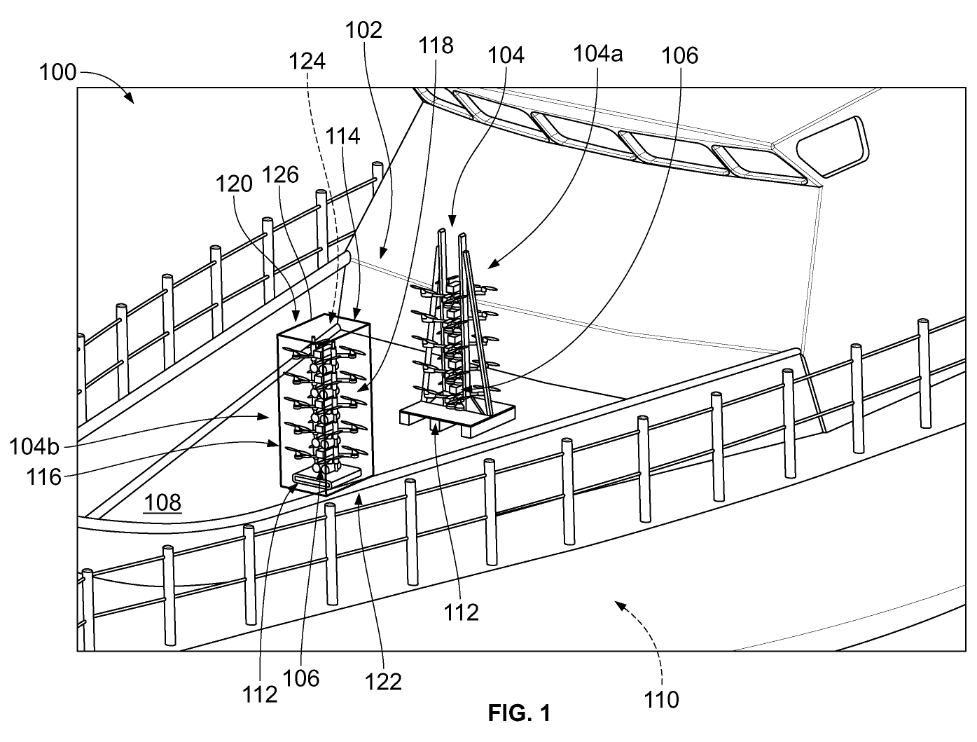

Referring now to the figures, FIG. 1 illustrates an example implementation of an aquatic platform 100 that includes a launching system 102 that includes one or more stacks 104 of mobile platforms 106. The launching system 102 is configured such that the mobile platforms 106 are configured to launch directly from the aquatic platform 100. For example, each stack 104 of the mobile platforms 106 may be configured to launch from a deck 108 of the aquatic platform 100 and/or may be configured to launch from within an enclosure 110 of the aquatic platform 100. A portion and/or an entirety of the launching system 102 may be referred to herein as a “launching assembly” and/or a “launching container assembly”.

In the example implementation of FIG. 1, the launch system 102 of the aquatic platform 100 includes a stack 104a of the mobile platforms 106 and a stack 104b of the mobile platforms. Although the stack 104a includes five mobile platforms 106 and the stack 104b includes five mobile platforms 106, each stack 104 of the mobile platforms 106 may include any number of mobile platforms 106. Moreover, although two stacks 104 are shown in the example implementation of FIG. 1, the aquatic platform 100 may hold any number of stacks 104 of mobile platforms 106.

Referring first to the stack 104a, a base 112 of the stack 104a is supported by the deck 108 (e.g., mounted to, resting on, secured to, etc.) such that the deck 108 provides a surface from which the mobile platforms 106 are configured to launch directly from the stack 104a. In other words, each mobile platform 106 is configured to be launched directly from the stack 104a and directly from the deck 108 of the aquatic platform 100. In some examples, one or more mobile platforms 106 launches directly from the deck 108 by moving (e.g., exiting, leaving, flying, etc.), under its own power, off the stack 104a. For example, in an example implementation wherein the mobile platforms 106 are UAVs, the mobile platforms 106 may launch directly from the deck 108 by flying off the stack 104a under their own power. In some examples, direct launch of a mobile platform 106 from the deck 108 of the aquatic platform 100 is assisted by facilitating (e.g., initiating, boosting, replacing, propelling, etc.) the acceleration of the mobile platform 106 off the stack 104a, for example by spring loading the mobile platforms 106, using a linear motor device (e.g., a rail gun, etc.), using a catapult (e.g., a steam catapult, a mechanical catapult, a pneumatic catapult, etc.), using a propellant (e.g., a fuel, a rocket fuel, a solid fuel, a liquid fuel, a gaseous fuel, a liquid propellant, a solid propellent, a gaseous propellant, a gas turbine engine, a jet, a propeller, an airfoil, etc.), using a pneumatic launcher, using a push and/or pull device (e.g., hydraulic, mechanical, pneumatic, electromechanical, etc.), using an ejection device, and/or the like. In some examples, one or more of the mobile platforms 106 is removed from the stack 104a before being deployed, for example manually, automatically, autonomously, and/or the like.

Referring now to the stack 104b, the stack 104b of mobile platforms 106 is held by a container 114 of the launch system 102. The container 114 includes a body 116 that includes an interior compartment 118 that is configured to hold the stack 104b of mobile platforms 106 therein. In some examples, the stack 104b of mobile platforms 106 is held within the interior compartment 118 of the container 114 such that the mobile platforms 106 rest on each other and/or are supported by one or more supports. In some examples, the container 114 includes a shipping container, such as, but not limited to, a standard intermodal container for freight transport that complies with International Organization for Standardization (ISO) standards (e.g., ISO standard 668:2020, etc.), and/or the like. A combination of the stack 104b and the container 114 may be referred to herein as a “launching container assembly”.

The body 116 of the container 114 extends a length from an end 120 to an end 122. The body 116 includes an opening 124 at the end 120 and/or at the end 122 that opens the interior compartment 118. The opening 124 enables the mobile platforms 106 to exit the interior compartment 118 therethrough during launch of the mobile platforms 106 from the container 114. Optionally, the body 116 includes a cover, lid, and/or top 126 that at least partially covers the opening 124, for example to protect the stack 104b and/or seal the interior compartment 118 during transport, storage, and/or the like. The cover, lid, and/or top 126 may provide tip-over protection, camouflage, environmental protection (e.g., from dust, dirt, water, sand, debris, salt, spray, etc.), and/or the like. The opening 124 of the container 114 may be referred to herein as an “exit opening”. Each of the ends 120 and 122 may be referred to herein as a “first” and/or a “second” end.

The cover, lid, and/or top 126 is selectively removable, releasable, detachable, openable, and/or the like to enable the mobile platforms 106 to exit the container 114 through the opening 124 (e.g., during launch thereof, etc.). For example, the top 126 may be configured to move from a closed position to an open position such that the mobile platforms 106 are configured to be launched from the interior compartment 118 through the exit opening 124 of the body 116 that is present when the top 126 is in the open position. The top 126 is moveable from the closed position to the open position using any method, mechanism, structure, means, geometry, configuration, type, and/or the like that enables the top 126 to function as described and/or illustrated herein. In some examples, the top 126 of the container 114 includes a door that provides the opening 124 through which the mobile platforms 106 exit the interior compartment 118. For example, the top 126 may include a panel door (e.g., similar to conventional garage door, a single panel door, a multi-panel sectional door, sectional panel doors that fold, etc.) that is configured to move to the open position by moving (e.g., using rails, tracks, wheels, conveyors, cables, etc.) along the side walls and/or the end walls of the container 114. Some examples of the top 126 include a roller door that is configured to wind, roll, and/or the like up (e.g., around a spool, etc.) to retract to the open position and unwind (e.g., wind out, unspool, roll out, etc.) to extend to the closed position. Examples of other types of doors that may be additionally or alternatively included by the top 126 include, but are not limited to, hinged doors, flexible sheets, explosive panels, sectional doors, clamshell arrangements (e.g., twin door panels that are hinged to open away from each other, etc.), and/or the like. In one example of a hinged door, one or more sections of the top 126 are hinged to lift upward. In some examples, providing the top 126 with a clamshell arrangement enables the top 126 to open more fully to increase the size of the exit opening 124 of the container 114 in the open position. The top 126 may include any type of hardware that enables the top 126 to function as described and/or illustrated herein, for example jamb type hardware, track type hardware, tracks, rails, rods, hinges, rollers, springs, torsion springs, extension springs, counterbalances, lift mechanisms, and/or the like.

In the example implementation of FIG. 1, the end 122 is closed, for example to provide a bottom of the container 114. In some other examples, the body 116 of the container 114 includes an opening at the end 122 (in addition or alternatively to the opening 124 at the end 120), for example to enable the mobile platforms 106 to launch through the end 122. Moreover, in addition or alternatively to the opening 124 and/or an opening at the end 122, at least a portion of one or more of the end walls and/or one or more of the side walls of the container 114 may be configured to open to enable the mobile platforms 106 to launch directly from the interior compartment 118 of the container 114.

In the example implementation of FIG. 1, the end 122 of the container 114 is supported by the deck 108 (e.g., mounted to, resting on, secured to, etc.) such that the deck 108 provides a surface from which the mobile platforms 106 of the stack 104b are configured to launch (e.g., deploy, etc.) directly from the container 114 and the deck 108. In other words, each mobile platform 106 is configured to be launched directly from the stack 104b and directly from the interior compartment 118 of the container 114. The mobile platforms 106 launch directly from the interior compartment 118 of the container 114 by exiting the interior compartment 118 through the exit opening 124 (e.g., provided by the open position of the top 126, etc.). In some examples, a mobile platform 106 may launch directly from the interior compartment 118 of the container 114 by moving (e.g., exiting, leaving, flying, etc.), under its own power, through the opening 124 at the end 120 of the container 114 (e.g., through an open top 126, etc.). In an example implementation wherein the mobile platforms 106 are UAVs, the mobile platforms 106 may launch directly from the container 114 by flying through the opening 124 under their own power. In some examples, direct launch of a mobile platform 106 from the container 114 is assisted by facilitating (e.g., initiating, boosting, replacing, propelling, etc.) the acceleration of the mobile platform 106 off the stack 104b and through the opening 124, for example by spring loading the mobile platforms 106, using a linear motor device (e.g., a rail gun, etc.), using a catapult (e.g., a steam catapult, a mechanical catapult, a pneumatic catapult, etc.), using a propellant (e.g., a fuel, a rocket fuel, a solid fuel, a liquid fuel, a gaseous fuel, a liquid propellant, a solid propellent, a gaseous propellant, a gas turbine engine, a jet, a propeller, an airfoil, etc.), using a pneumatic launcher, using a push and/or pull device (e.g., hydraulic, mechanical, pneumatic, electromechanical, etc.), using an ejection device, and/or the like. In some examples, one or more of the mobile platforms 106 is removed from the stack 104b before being deployed, for example manually, automatically, autonomously, and/or the like.

In an example implementation, the stack 104a is oriented approximately vertical on the deck 108, the container 114 is oriented approximately vertical on the deck 108, and the stack 104b is oriented approximately vertical within the interior compartment 118. In other implementations, the stack 104a and/or the container 114 extend at an approximate oblique angle relative to the deck 108 and/or the stack 104b extends obliquely within the interior compartment 118.

The container 114, the stack 104a of mobile platforms 106, and/or the stack 104b of mobile platforms 106 are configured for use in one or more aquatic environments. For example, the body 116 of the container 114 and/or the stacks 104 may be configured to withstand (e.g., be resistant to, be durable against, etc.) corrosion, pressure, stress, fatigue, and/or the like, for example from wave conditions (e.g., wave loading, etc.), sea conditions, swell conditions, wind conditions, salt, salt spray, corrosion, dust, dirt, water, sand, debris, corrosive liquids, and/or like encountered by the launch system 102 in aquatic environments. In some examples, the body 116 of the container 114 and/or the stacks 104 are configured to withstand environmental exposure to humidity, relatively high-salt environments, splash zones, submerged conditions, and/or the like in aquatic environments.

For example, the materials of the body 116 of the container 114 and/or the stacks 104 may be selected based on toughness, strength, fracture and/or penetration resistance, fatigue resistance, corrosion resistance, strength-to-weight ratio, weldability (e.g., weldable without reducing strength and/or corrosion resistance, etc.), and/or the like. Materials selected for the body 116 and/or the stacks 104 may include, but are not limited to, aluminum, steel, stainless steel, structural steels, alloy steels, duplex stainless steel, corrosion-resistant materials, red brass (e.g., CDA 230, etc.), inhibited admiralty brass, monel, titanium, plastics, polyethylene, high density polyethylene (HPDE), composites, carbon fiber, polyvinyl chloride (PVC), and/or the like. Grade 316 stainless steel may provide resistance to saltwater pitting (e.g., due to the molybdenum content, etc.) in some examples. Marine-grade steels (e.g., MD, ME, MF, MG, AH36, DH36, EH36, etc.) are utilized in some examples, for example because the manganese and/or chromium content enable marine-grade steels to resist corrosion. In some examples, galvanized steel is utilized, for example in freshwater aquatic environments, etc. Examples of aluminum that may be utilized in the body 116 and/or the stacks 104 include, but are not limited to, marine-grade aluminum alloys (e.g., 5,000 series, 6,000 series, etc.), freshwater-grade aluminum alloys, and/or the like. In some examples, the body 116 and/or the stacks 104 utilize bronze (e.g., silicon bronze, aluminum bronze, etc.) and/or copper-nickel alloys (e.g., C70600, C71500, etc.), for example for fasteners, other components, and/or the like.

Optionally, the body 116 and/or the stacks 104 include corrosion protection such as, but not limited to, galvanizing, protective coatings (e.g., anti-corrosive coatings, etc.), PTFE coatings, anodes to manage galvanic and crevice corrosion. In some examples, salt spray testing is utilized to confirm one or more of the structures of the container body 116 and/or the stacks 104.

In some examples, the body 116 of the container 114 and/or the stacks 104 are configured with a toughness, strength, durability, fatigue resistance, and/or the like that is configured to withstand an aquatic environment, for example the ability to withstand relatively high loads in relatively rough waters, and/or the like. For example, the body 116 and/or the stacks 104 may undergo overload tests, no-load tests, electric insulation test, and/or the like. Optionally, a three-dimensional (3D) software model is utilized to determine the load capacity of one or more structures of the body 116 and/or the stacks 104. In some examples, one or more structures of the body 116 and/or the stacks 104 is tested for durability against cyclic loading from wind and/or waves. Optionally, one or more structures of the body 116 and/or the stacks 104 is configured with an impact resistance over a threshold value, for example to prevent brittle fracture (e.g., in relatively cold temperatures, etc.). In some examples, the body 116 and/or one or structures of the stacks 104 includes a crack tip opening displacement (CTOD) score of at least approximately 0.15mm, at least approximately 0.25mm, and/or the like.

In some examples, the body 116 of the container 114 and/or one or more structures of the stacks 104 is configured with an ingress protection that provides resistance against the intrusion of dust, water, salt spray, other liquids, and/or the like. For example, the body 116 and/or one or more structures of the stacks 104 may have an ingress protection (IP) rating of IP67, IP68, and/or IP69, in some examples. Optionally, safety factors for components of the launch system 102 are relatively high (e.g., with a 5:1 ratio, etc.), for example to account for unpredictable loads.

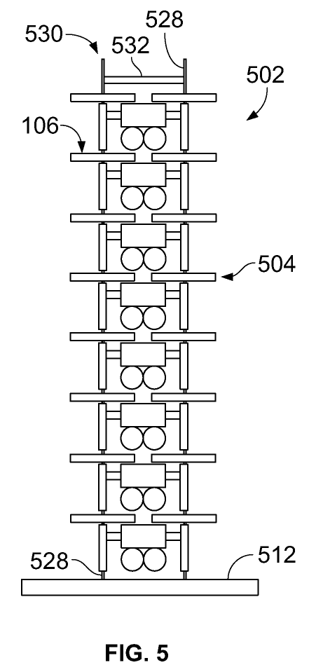

Optionally, the container 114 and/or one or more of the stacks 104 includes one or more support members (e.g., the support member 532 shown in FIG. 5) that extend within the interior compartment 118 of the container 114 to support, stabilize, strengthen, and/or the like the stack(s) 104 within the interior compartment of the container 114. For example, one or more support members may be configured to engage in physical contact with one or more components of the stack 104 (e.g., a guide element, a mobile platform 106, etc.). The support members may facilitate holding the mobile platforms 106 within the interior compartment 118 of the container 114, may facilitate spacing the mobile platforms 106 apart from each other within the stack 104, and/or the like. Although any other geometry, configuration, and/or the like of the support members may additionally or alternatively be used, examples of the support members include, but are not limited to, lateral support members that extend radially inward within the interior compartment 118, fins, grooves, cross members, and/or the like. The support member(s) may be utilized with or without the container 114 (e.g., may be utilized with the stack 104a and/or may be utilized with the stack 104b, etc.).

Referring now to FIG. 5, an example implementation of a launching system 502 includes a stack 504 of the mobile platforms 106. The stack 504 includes a base 512 and one or more guide elements 528 that extend lengths from the base 512 to ends 530 of the guide elements 528. In some examples, the guide elements 528 are configured to: guide the mobile platforms 106 during launch thereof from the stack 504, and/or hold the mobile platforms 106 in alignment within the stack 504. Although illustrated as two guide rods, the guide elements 528 may additionally or alternatively include any other number, type, structure, geometry, mechanism, and/or the like, such as, but not limited to, a rail, a support, a bracket, a tube, a fin, and/or the like. In some examples, the guide elements 528 include approximately vertical guide elements. In addition or alternatively, one or more of the guide elements 528 extends approximately horizontally and/or at an oblique angle. A portion and/or an entirety of the launching system 502 may be referred to herein as a “launching assembly” and/or a “launching container assembly”.

The stack 504 of mobile platforms 106 includes a support member 532 that interconnects the ends 530 of the guide elements 528. In the example implementation of FIG. 5, the support member 532 is a cross member that extends across a gap between the guide elements 528 to interlock the ends 530 of the guide elements 528 together. In some examples, the support member 532 enables the stack 504 to withstand higher loads (e.g., pitching, rocking, and/or rolling loads from wave action, etc.). For example, the support member 532 reduces or prevents lateral displacement, for example during transit, shipping, and/or handling operations. Moreover, and for example, the support member 532 resists movement of the guide elements 528 and/or the mobile platforms 106 caused by tilting, loading forces, handling forces, vibrations, dynamic forces experienced during launch, wave action, and/or the like. The support member 532 distributes loads across the guide elements 528, reducing stress concentrations on individual components and enhancing overall system stability, for example during transit, shipping, and/or handling operations. The technical solution of the support member 532 provides the technical effect of improving stability and operational integrity.

Although shown as interconnecting the ends 530, the stack 504 may additionally or alternatively include one or more support members 532 that interconnects the guide elements 528 at one or more other locations along the lengths thereof. Although one is shown, the stack 504 may include any number of the support members 532.

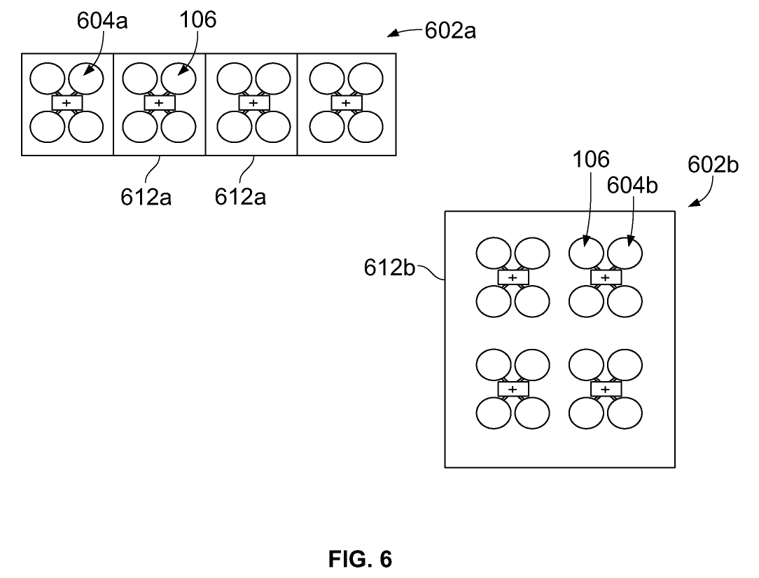

Referring now to FIG. 6, an example implementation of a launching system 602a includes stacks 604a of the mobile platforms 106. The stacks 604a include bases 612a that are interconnected together. For example, the bases 612a are daisy-chained together in the example of FIG. 6. In some examples, the interconnected bases 612a hold the stacks 604a in fixed positions relative to each other and/or provide a dedicated framework to support mobile platform storage and/or deployment arrangements. For example, the interconnected bases 612a may include pallets that are configured to interlock with each other, for example interlocking together into a grid of the pallets.

Optionally, the bases 612a include stabilization features that, for example, function through mechanical interlocking that reduces or prevents lateral displacement, for example during transit, shipping, and/or handling operations. In some examples, when the bases 612a are interlocked together, complementary shapes of the bases 612a create physical barriers that resist movement caused by tilting, loading forces, handling forces, vibrations, wave action, and/or the like. Optionally, interlocking edges of the bases 612a distribute loads across multiple base interfaces, reducing stress concentrations on individual components and enhancing overall system stability, for example during transit, shipping, and/or handling operations.

In some examples, the interconnected bases 612a enables the stacks 604a to withstand higher loads (e.g., pitching, rocking, and/or rolling loads from wave action, etc.). For example, the interconnected bases 612a reduce or prevent lateral displacement, for example during transit, shipping, and/or handling operations. Moreover, and for example, the interlocked bases 612a resist movement of the mobile platforms 106 caused by tilting, loading forces, handling forces, vibrations, dynamic forces experienced during launch, wave action, and/or the like. The interconnected bases 612a distribute loads across the stacks 604a, reducing stress concentrations on individual components and enhancing overall system stability, for example during transit, shipping, and/or handling operations. The technical solution of the interconnected bases 612a provides the technical effect of improving stability and operational integrity.

FIG. 6 also illustrates an example implementation of a launching system 602b that includes stacks 604b of the mobile platforms 106. The stacks 604b include a common base 612b. In some examples, the common base 612b hold the stacks 604b in fixed positions relative to each other and/or provide a dedicated framework to support mobile platform storage and/or deployment arrangements. For example, the common base 612b may include a pallet and/or the like.

Optionally, the common base 612b includes stabilization features that, for example, function through mechanical interlocking that reduces or prevents lateral displacement, for example during transit, shipping, and/or handling operations. In some examples, the common base 612b distributes loads across multiple stack 604b, reducing stress concentrations on individual components and enhancing overall system stability, for example during transit, shipping, and/or handling operations. Optionally, the common base 612b enables the stacks 604b to withstand higher loads (e.g., pitching, rocking, and/or rolling loads from wave action, etc.). For example, the common base 612b reduces or prevents lateral displacement, for example during transit, shipping, and/or handling operations. Moreover, and for example, the common base 612b resists movement of the mobile platforms 106 caused by tilting, loading forces, handling forces, vibrations, dynamic forces experienced during launch, wave action, and/or the like. The common base 612b distributes loads across the stacks 604b, reducing stress concentrations on individual components and enhancing overall system stability, for example during transit, shipping, and/or handling operations. The technical solution of the common base 612b provides the technical effect of improving stability and operational integrity. A portion and/or an entirety of each of the launching systems 602a and/or 602b may be referred to herein as a “launching assembly” and/or a “launching container assembly”. Each of the stacks 604a and/or each of the stacks 604b may be referred to herein as a “first” and/or a “second” stack of mobile platforms.

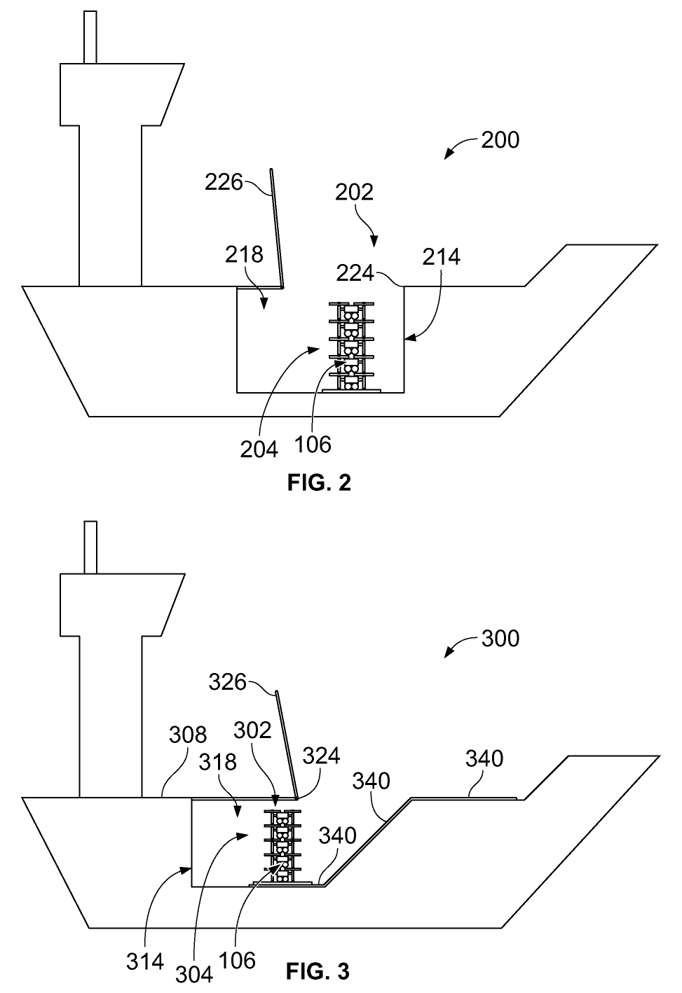

Referring now to FIG. 2, an example implementation of an aquatic platform 200 includes a launching system 202 that includes one or more stacks 204 of the mobile platforms 106. The launching system 202 is configured such that the mobile platforms 106 are configured to launch directly from within an enclosure 214 of the aquatic platform 200. A portion and/or an entirety of the launching system 202 may be referred to herein as a “launching assembly” and/or a “launching container assembly”.

The enclosure 214 includes an interior compartment 218 and an opening 224 that opens the interior compartment 218. The opening 224 enables the mobile platforms 106 to exit the interior compartment 218 therethrough during launch of the mobile platforms 106 from the enclosure 214. Optionally, the enclosure 214 includes a cover, lid, and/or top 226 that at least partially covers the opening 224, for example to protect the stack 204 and/or seal the interior compartment 218 during transport, storage, and/or the like. The cover, lid, and/or top 226 may provide camouflage, environmental protection (e.g., from dust, dirt, water, sand, debris, salt, spray, etc.), and/or the like. The opening 224 of the enclosure 214 may be referred to herein as an “exit opening”.

The cover, lid, and/or top 226 is selectively removable, releasable, detachable, openable, and/or the like to enable the mobile platforms 106 to exit the enclosure 214 through the opening 224 (e.g., during launch thereof, etc.). For example, the top 226 may be configured to move from a closed position (not shown) to an open position (shown in FIG. 2) such that the mobile platforms 106 are configured to be launched from the interior compartment 218 through the exit opening 224 of the enclosure 214 that is present when the top 226 is in the open position. The top 226 is moveable from the closed position to the open position using any method, mechanism, structure, means, geometry, configuration, type, and/or the like that enables the top 226 to function as described and/or illustrated herein. In some examples, the top 226 of the enclosure 214 includes a door that provides the opening 224 through which the mobile platforms 106 exit the interior compartment 218. For example, the top 226 may include a hatch as is shown in FIG. 2. In some examples, the top 226 includes a panel door (e.g., similar to conventional garage door, a single panel door, a multi-panel sectional door, sectional panel doors that fold, etc.) that is configured to move to the open position by moving (e.g., using rails, tracks, wheels, conveyors, cables, etc.) along a side wall of the enclosure 214. Some examples of the top 226 include a roller door that is configured to wind, roll, and/or the like up (e.g., around a spool, etc.) to retract to the open position and unwind (e.g., wind out, unspool, roll out, etc.) to extend to the closed position. Examples of other types of doors that may be additionally or alternatively included by the top 226 include, but are not limited to, hinged doors, flexible sheets, explosive panels, sectional doors, clamshell arrangements (e.g., twin door panels that are hinged to open away from each other, etc.), and/or the like. In one example of a hinged door, one or more sections of the top 226 are hinged to lift upward. In some examples, providing the top 226 with a clamshell arrangement enables the top 226 to open more fully to increase the size of the exit opening 224 of the enclosure 214 in the open position. The top 226 may include any type of hardware that enables the top 226 to function as described and/or illustrated herein, for example jamb type hardware, track type hardware, tracks, rails, rods, hinges, rollers, springs, torsion springs, extension springs, counterbalances, lift mechanisms, and/or the like.

In some other examples, the enclosure 214 includes an opening along a bottom and/or along sides of the enclosure 214 (in addition or alternatively to the opening 224), for example to enable the mobile platforms 106 to launch directly from the interior compartment 218 of the enclosure 214 through the sides and/or bottom of the enclosure 214.

In the example implementation of FIG. 2, the stack 204 is supported by a floor of the enclosure 214 (e.g., mounted to, resting on, secured to, etc.) such that the floor of the enclosure 214 provides a surface from which the mobile platforms 106 of the stack 204 are configured to launch (e.g., deploy, etc.) directly from the enclosure 214. In other words, each mobile platform 106 is configured to be launched directly from the stack 204 and directly from the interior compartment 218 of the enclosure 214. The mobile platforms 106 launch directly from the interior compartment 218 of the enclosure 214 by exiting the interior compartment 218 through the exit opening 224 (e.g., provided by the open position of the top 226, etc.). In some examples, a mobile platform 106 may launch directly from the interior compartment 218 of the enclosure 214 by moving (e.g., exiting, leaving, flying, etc.), under its own power, through the opening 224 (e.g., through an open top 226, etc.). In an example implementation wherein the mobile platforms 106 are UAVs, the mobile platforms 106 may launch directly from the enclosure 214 by flying through the opening 224 under their own power. In some examples, direct launch of a mobile platform 106 from the enclosure 214 is assisted by facilitating (e.g., initiating, boosting, replacing, propelling, etc.) the acceleration of the mobile platform 106 off the stack 204 and through the opening 224, for example by spring loading the mobile platforms 106, using a linear motor device (e.g., a rail gun, etc.), using a catapult (e.g., a steam catapult, a mechanical catapult, a pneumatic catapult, etc.), using a propellant (e.g., a fuel, a rocket fuel, a solid fuel, a liquid fuel, a gaseous fuel, a liquid propellant, a solid propellent, a gaseous propellant, a gas turbine engine, a jet, a propeller, an airfoil, etc.), using a pneumatic launcher, using a push and/or pull device (e.g., hydraulic, mechanical, pneumatic, electromechanical, etc.), using an ejection device, and/or the like. In some examples, one or more of the mobile platforms 106 is removed from the stack 204 before being deployed, for example manually, automatically, autonomously, and/or the like.

The enclosure 214 may include any internal compartment of the aquatic platform 200, such as, but not limited to, a hold, a control room, an engine room, quarters, engineering, and/or the like.In some examples, the enclosure 214 defines a container (e.g., the container 114, etc.) as disclosed herein. For example, in the implementation of FIG. 2, a body of the container is defined by one or more internal structures (e.g., walls, floors, ceilings, etc.) of the enclosure 214 that form (e.g., bound, define, etc.) the interior compartment 218.

Referring now to FIG. 3, an example implementation of an aquatic platform 300 includes a launching system 302 that includes one or more stacks 304 of the mobile platforms 106. The launching system 302 is configured such that the mobile platforms 106 are configured to launch directly from a deck 308 of the aquatic platform 300 by being moved from within an enclosure 314 of the aquatic platform 300 to the deck 308 prior to launch. A portion and/or an entirety of the launching system 302 may be referred to herein as a “launching assembly” and/or a “launching container assembly”.

The enclosure 314 includes an interior compartment 318 and an opening 324 that opens the interior compartment 318. The opening 324 enables the mobile platforms 106 to exit the interior compartment 318 therethrough and be moved to the deck 308 for launch of the mobile platforms 106 from the aquatic platform 300. Optionally, the enclosure 314 includes a door 326 that at least partially closes the opening 324, for example to protect the stack 304 and/or seal the interior compartment 318 during transport, storage, and/or the like. The door 326 may provide camouflage, environmental protection (e.g., from dust, dirt, water, sand, debris, salt, spray, etc.), and/or the like. The opening 324 of the enclosure 314 may be referred to herein as an “exit opening”.

The door 326 is selectively removable, releasable, detachable, openable, and/or the like to enable the mobile platforms 106 to exit the enclosure 314 through the opening 324 for relocation to the deck 308 for launch. For example, the door 326 may be configured to move from a closed position (not shown) to an open position (shown in FIG. 3) such that the mobile platforms 106 are configured to be moved to the deck 308 from the interior compartment 318 through the exit opening 324 of the enclosure 314 that is present when the door 326 is in the open position. The door 326 is moveable from the closed position to the open position using any method, mechanism, structure, means, geometry, configuration, type, and/or the like that enables the door 326 to function as described and/or illustrated herein. In some examples, the door 326 includes a hatch. In some examples, the door 326 includes a panel door (e.g., similar to conventional garage door, a single panel door, a multi-panel sectional door, sectional panel doors that fold, etc.), a roller door, a hinged door, a flexible sheet, an explosive panel, a sectional door, a clamshell arrangement, and/or the like. The door 326 may include any type of hardware that enables the door 326 to function as described and/or illustrated herein, for example jamb type hardware, track type hardware, tracks, rails, rods, hinges, rollers, springs, torsion springs, extension springs, counterbalances, lift mechanisms, and/or the like.

In some other examples, the enclosure 314 includes an opening along a bottom and/or along sides of the enclosure 314 (in addition or alternatively to the opening 324), for example to enable the mobile platforms 106 to be relocated to the deck 308 for launch through the sides and/or bottom of the enclosure 314.

The enclosure 314 may include any internal compartment of the aquatic platform 300, such as, but not limited to, a hold, a control room, an engine room, quarters, engineering, and/or the like.In some examples, the enclosure 314 defines a container (e.g., the container 114, etc.) as disclosed herein. For example, in the implementation of FIG. 3, a body of the container is defined by one or more internal structures (e.g., walls, floors, ceilings, etc.) of the enclosure 314 that form (e.g., bound, define, etc.) the interior compartment 318.

In some examples, the stack 304 of mobile platforms 106 is moved from the enclosure 314 to the deck 308 of the aquatic platform 300 utilizing a rail, a wheel, a cable, a conveyor, a track, and/or the like. For example, the example implementation of FIG. 3 includes a rail 340 along which the stack 304 is configured to move between the enclosure 314 and the deck 308. Optionally, movement of the stack 304 is automated (e.g., featuring conveyor mechanisms and/or robotic arms, etc.), which reduces manual handling, for example decreasing the risk of damage and improving precision.

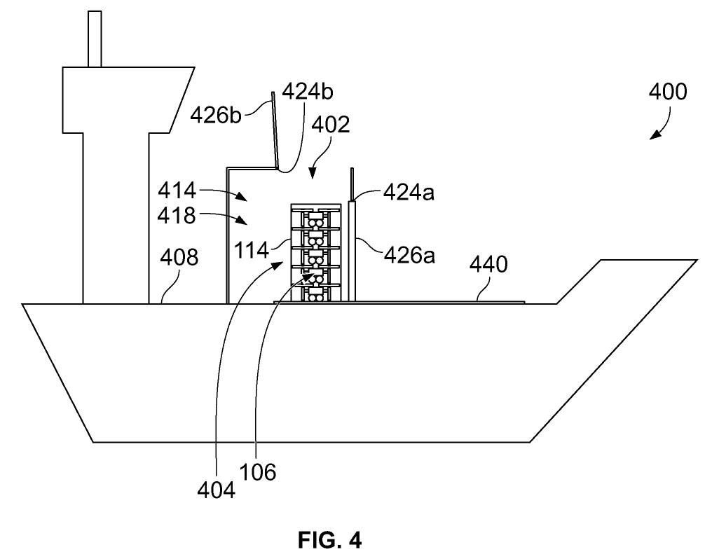

Referring now to FIG. 4, an example implementation of an aquatic platform 400 includes a launching system 402 that includes the container 114 and one or more stacks 404 of the mobile platforms 106 held by the container 114. The launching system 402 is configured such that the mobile platforms 106 are configured to launch directly from the container 112 and a deck 408 of the aquatic platform 400 by being moved from within an enclosure 414 of the aquatic platform 400 to the deck 408 prior to launch. In the example implementation of FIG. 4, the launching system 402 is also configured such that the mobile platforms 106 are configured to launch directly from the container 114 and directly from within an interior compartment 418 of the enclosure 414. A portion and/or an entirety of the launching system 402 may be referred to herein as a “launching assembly” and/or a “launching container assembly”. A combination of the stack 404 and the container 114 may be referred to herein as a “launching container assembly”.

The enclosure 414 includes the interior compartment 418 and openings 424a and 424b that open the interior compartment 418. The opening 424a enables the mobile platforms 106 to exit the interior compartment 418 therethrough and be moved to the deck 408 for launch of the mobile platforms 106 from the deck 408 of the aquatic platform 400. Optionally, the enclosure 414 includes a door 426a that is selectively removable, releasable, detachable, openable, and/or the like to enable the mobile platforms 106 to exit the enclosure 414 through the opening 424a for relocation to the deck 408 for launch. For example, the door 426 may be configured to move from a closed position (shown in FIG. 4) to an open position (not shown) such that the mobile platforms 106 are configured to be moved to the deck 408 from the interior compartment 418 through the opening 424a of the enclosure 414 that is present when the door 426 is in the open position. Each of the openings 424a and 424b of the enclosure 414 may be referred to herein as an “exit opening”.

The opening 424b enables the mobile platforms 106 to be launched directly from the container 114 and the enclosure 414 through the opening 424b of the enclosure 414. Optionally, the enclosure 414 includes a top 426b that is selectively removable, releasable, detachable, openable, and/or the like to enable the mobile platforms 106 to be launched directly from the enclosure 414 by exiting the enclosure 414 through the opening 424b. For example, the top 426b may be configured to move from a closed position (not shown) to an open position (shown in FIG. 4) such that the mobile platforms 106 are configured to be exit the interior compartment 418 through the opening 424b of the enclosure 414 that is present when the top 426b is in the open position.

The enclosure 414 may include any internal compartment of the aquatic platform 400, such as, but not limited to, a hold, a control room, an engine room, quarters, engineering, and/or the like.In some examples, in addition to the container 114, the enclosure 414 defines a container as disclosed herein. For example, in the implementation of FIG. 4, a body of the container is defined by one or more internal structures (e.g., walls, floors, ceilings, etc.) of the enclosure 414 that form (e.g., bound, define, etc.) the interior compartment 418.

In some examples, the stack 404 of mobile platforms 106 is moved from the enclosure 414 to the deck 408 of the aquatic platform 400 utilizing a rail, a wheel, a cable, a conveyor, a track, and/or the like. For example, the example implementation of FIG. 4 includes a rail 440 along which the stack 404 is configured to move between the enclosure 414 and the deck 408. Optionally, movement of the stack 404 is automated (e.g., featuring conveyor mechanisms and/or robotic arms, etc.), which reduces manual handling, for example decreasing the risk of damage and improving precision.

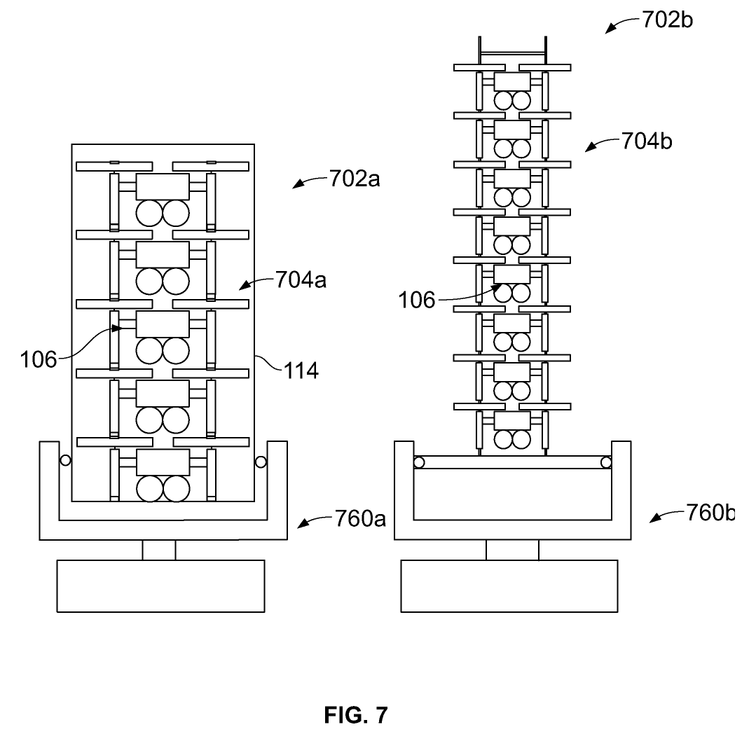

FIG. 7 illustrates example implementations of launching systems 702a and 702b that optionally include gimbal systems 760a and 760b, respectively, that are configured to control, change, and/or the like an orientation of corresponding stacks 704a and 704b of the mobile platforms 106 relative to the aquatic platform (e.g., relative to a deck of the aquatic platform, etc.). A portion and/or an entirety of each of the launching systems 702a and 702b may be referred to herein as a “launching assembly” and/or a “launching container assembly”. A combination of the stack 704a and the container 114 may be referred to herein as a “launching container assembly”.

For example, the gimbal systems 760a and/or 760b may be configured to orient the respective stack 704a and 704b within an orientation range (e.g., within a range of an approximately horizontal orientation, etc.) when the orientation (e.g., a pitch, a roll, etc.) of the aquatic platform is outside the orientation range (e.g., when the deck of the aquatic platform is at an oblique angle that is outside an orientation range that includes an approximately horizontal orientation, etc.). The gimbal systems 760a and 760b enable the mobile platforms 106 to be launched from the aquatic platform from an approximately horizontal orientation even when the aquatic platform (e.g., the deck, a floor of an enclosure, etc.) is oriented obliquely, for example because the aquatic platform is pitching, rolling, and/or the like with waves. In some other examples, the gimbal systems 760a and 760b enable the mobile platforms 106 to be launched from the aquatic platform from an approximately oblique orientation, for example to enable the mobile platforms 106 to be launched from the aquatic platform in sideways (e.g., port, starboard, etc.), forward, and backward orientations relative to the aquatic platform. Optionally, the gimbal system 760a and/or 760b may include a gyroscope and/or other components that enable the gimbal system 760a and/or 760b to function as described and/or illustrated herein. In some examples, a gyroscope is utilized in addition or alternative to the gimbal systems 760a and/or 760b.

In addition or alternatively to controlling and/or changing the orientation of the stacks 704a and/or 704b for launch, a control system (e.g., of the aquatic platform, remote from the aquatic platform, onboard one or more of the mobile platforms 106, etc.) may be configured to communicate with the launching system 702a and/or 702b to initiate launch of the mobile platforms 106 when an orientation (e.g., a pitch, a roll, etc.) of the aquatic platform is within an orientation range, for example when the aquatic platform (e.g., the deck, a floor of an enclosure, etc.) is oriented within an orientation range that includes an approximately horizontal orientation. The control system enables the mobile platforms 106 to be launched from the aquatic platform from an approximately horizontal orientation by waiting for the aquatic platform (e.g., the deck, a floor of an enclosure, etc.) to be oriented approximately horizontally (or within a range that includes a horizontal orientation) as the aquatic platform pitches, rolls, and/or the like with waves. The control system may determine that the aquatic platform is within the orientation range utilizing any means, mechanism, method, device, and/or the like, such as, but not limited to, utilizing a gyroscope and/or the like.

Optionally, the control system is configured to determine whether to initiate launch of the mobile platforms 106 based on one or more environmental conditions, a water roughness, a safe condition, and/or the like. For example, an instrument and/or sensor pod of the control system may detect environmental and/or other conditions (e.g., temperature, pressure, barometric pressure, water roughness, wave heights, etc.) to determine whether the conditions are safe for launch or to wait for better conditions (e.g., the conditions are determined to be unsafe for launch, etc.). In some examples, one or more of the mobile platforms 106 communicates to the control system and/or one or more other mobile platforms 106 that an error (e.g., that may prevent, stop, terminate, and/or the like the launch, etc.), a safe condition, and/or an unsafe condition is present.

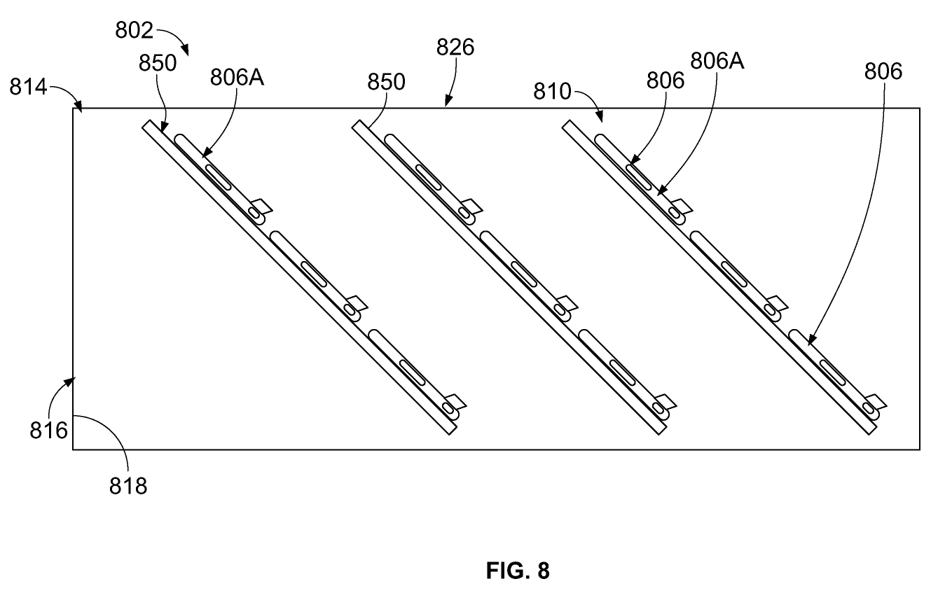

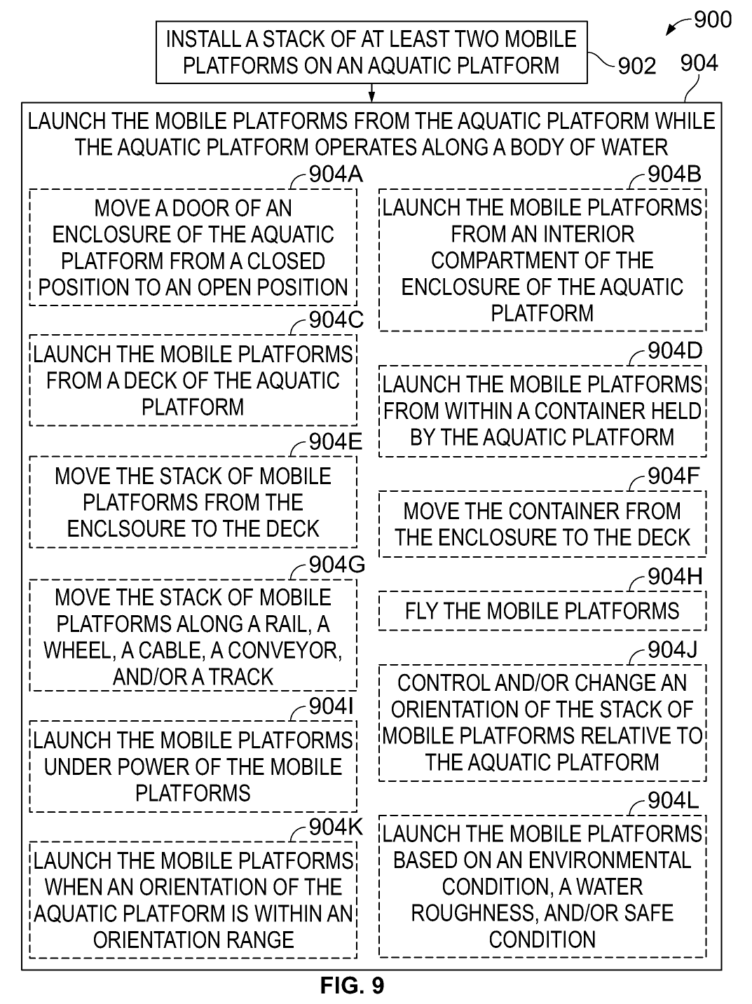

FIG. 8 illustrates a launching system 802 configured for launching mobile platforms 806 that include fixed-wing aircraft 806A. The launching system 802 includes a container 814 (e.g., the container 114, the enclosure 214, enclosure 314, the enclosure 414, etc.) and the fixed-wing mobile platforms 806A. The container 814 includes a body 816 that includes an interior compartment 818 that is configured to hold one or more magazines 850 of the mobile platforms 806 therein. The body 806 of the container 814 includes a top 826 that opens to enable the mobile platforms 806 to launch directly from the container 814 by exiting the interior compartment 818 through an exit opening of the open top 826. For example, the top 826 is moveable from a closed position (shown in FIG. 8) to an open position (not shown). In the open position, the open top 826 includes the exit opening (not shown). A portion and/or an entirety of the launching systems 802 may be referred to herein as a “launching assembly” and/or a “launching container assembly”.

Although illustrated herein with respect to rotorcraft and fixed-wing mobile platforms, as described above the disclosure is not limited thereto. In some examples, the launch systems of the disclosure include aquatic platforms that are configured to deploy uncrewed aquatic vehicles directly therefrom. In one example, one or more uncrewed aquatic vehicles having a payload of one or more UAVs can be held by and directly deployed from the aquatic platform (e.g., at the start of an operation and/or mission, etc.). Aspects of the disclosure utilizing uncrewed aquatic vehicles may provide the technical effect of extending the range of UAVs, for example because uncrewed aquatic vehicles are less weight-limited (as compared to UAVs) and can therefore carry larger and more capable energy systems (e.g., motors, batteries, fuel, solar, etc.).

FIG. 9 is a flowchart illustrating an example of a method 900. At 902, the method 900 includes installing a stack of at least two mobile platforms on an aquatic platform. At 904, the method 900 includes launching the mobile platforms from the aquatic platform while the aquatic platform operates along a body of water.

Optionally, launching at 904 the mobile platforms from the aquatic platform includes moving, at 904a, a door of an enclosure of the aquatic platform from a closed position of the door to an open position of the door.

In some examples, launching at 904 the mobile platforms from the aquatic platform includes launching, at 904b, the mobile platforms from an interior compartment of an enclosure of aquatic platform.

In some examples, launching at 904 the mobile platforms from the aquatic platform includes launching the mobile platforms from the interior compartment of the enclosure through an exit opening of the interior compartment.

Optionally, launching at 904 the mobile platforms from the aquatic platform includes launching, at 904c, the mobile platforms from a deck of the aquatic platform.

In some examples, launching at 904 the mobile platforms from the aquatic platform includes launching, at 904d, the mobile platforms from within a container that is held by the aquatic platform.

In some examples, launching at 904 the mobile platforms from the aquatic platform includes launching the mobile platforms from within a container that is held on a deck of the aquatic platform.

In some examples, launching at 904 the mobile platforms from the aquatic platform includes moving, at 904e, the stack of mobile platforms from the enclosure of the aquatic platform to the deck of the aquatic platform.

Optionally, launching at 904 the mobile platforms from the aquatic platform includes moving, at 904f, the container from the enclosure of the aquatic platform to the deck of the aquatic platform.

In some examples, launching at 904 the mobile platforms from the aquatic platform includes moving, at 904g, the stack of mobile platforms along at least one of a rail, a wheel, a cable, a conveyor, or a track.

Optionally, launching at 904 the mobile platforms from the aquatic platform includes flying, at 904h, the mobile platforms.

Optionally, launching at 904 the mobile platforms from the aquatic platform includes launching, at 904i, the mobile platforms under power of the mobile platforms.

Optionally, launching at 904 the mobile platforms from the aquatic platform includes propelling the mobile platforms.

In some examples, launching at 904 the mobile platforms from the aquatic platform includes at least one of automatically or remotely opening at least one of a door of aquatic platform or a top of a container.

In some examples, launching at 904 the mobile platforms from the aquatic platform includes manually opening at least one of the door or the top.

Optionally, launching at 904 the mobile platforms from the aquatic platform includes at least one of controlling or changing, at 904j, an orientation of the stack of mobile platforms relative to the aquatic platform.

In some examples, launching at 904 the mobile platforms from the aquatic platform includes launching, at 904k, the mobile platforms when an orientation of the aquatic platform is within an orientation range.

Optionally, launching at 904 the mobile platforms from the aquatic platform includes launching the mobile platforms when at least one of a pitch or a roll of the aquatic platform is within a range that includes an approximately horizontal orientation.

In some examples, launching at 904 the mobile platforms from the aquatic platform includes launching, at 904l, the mobile platforms based on at least one of an environmental condition, a water roughness, or a safe condition.

### Further Implementations

In contrast to existing methods and systems that require manual intervention, the launching container assemblies disclosed herein include, in some examples, remote and/or automated operations. For example, a control system (e.g., a remote control system, an automatic launching system, etc.) could feature automated and/or remote operation capabilities, for example including using computer systems to trigger, initiate, and/or the like mobile platform launch sequences from the aquatic platform automatically and/or remotely. In another example, a computer system automatically and/or remotely opens a top of the container and/or a door of the aquatic platform. The automatic and/or remote functionalities reduces the reliance on (e.g., on-site, etc.) personnel, for example enhancing safety.

Optionally, aspects of the disclosure include the interior compartment of the container and/or the enclosure being equipped with a dedicated framework to support mobile platform storage and/or deployment arrangements. For example, the framework may include a series of approximately vertical tubes for rotorcraft, for example strategically spaced to enable simultaneous and/or sequential launch. In another example of the framework, the container and/or the enclosure may include a floor grid, a rack, a palletized rack, and/or the like. For example, a floor grid may be provided for containing power supply (e.g., batteries, cabling, etc.) and/or other components. In an example of a palletized rack, a modular insert system could be provided within the container and/or the enclosure, for example where mobile platforms are preloaded onto removable palletized racks that facilitate easier transfer of mobile platform assemblies in and out of the container and/or the enclosure (e.g., using forklifts, cranes, etc.), for example optimizing turnaround and reloading times.

In some examples, a launch system as disclosed herein includes two or more different types of mobile platforms and/or two or more mobile platforms that perform different functions. For example, the launch system may include one or more rotorcraft and one or more fixed-wing aircraft. In an example of different functions, the launch system may include mobile platforms that perform different tasks such as, but not limited to: communication relay; intelligence, surveillance, and reconnaissance (ISR); effector; a special purpose function; and/or the like. In some examples, the mobile platforms are organized, arranged, and/or the like (e.g., in an order, etc.) based on the functionalities performed by the mobile platforms. In this way, the mobile platforms can be launched in an order based on the various functions of the mobile platforms. For example, the mobile platforms that are desired to be launched first may be organized at the top of a stack. In one example, mobile platforms with special tasks and/or ISR mobile platforms may be arranged to be the first launched. Optionally, the mobile platforms are launched in a checkerboard pattern.

Some examples include hierarchical standards for loading, unloading, and/or launching the mobile platforms. For example, a group of mobile platforms configured to perform a corresponding operation and/or mission may be packaged onto a corresponding base (e.g., pallet, etc.) and loaded into the container and/or enclosure for deployment of the operation and/or mission from the container and/or enclosure. In some examples, two or more bases containing mobile platforms dedicated to one or more different operations and/or missions may be loaded into the container and/or enclosure, for example to provide the capability of launching two or more missions directly from the aquatic platform. Similarly, two or more containers can be networked together. For example, the aquatic platform may be loaded with two or more of the containers to enable the deployment of one or more independent and/or coordinated missions that may be performed by any number, combination, arrangement, and/or the like of the carried containers.

In implementations wherein the aquatic platform includes a submersible, the mobile platforms may be launched directly from the submersible while the submersible is at the surface and/or may be launched directly from the submersible while the submersible is submerged (e.g., including flooding a container and/or an enclosure, etc.).

### Example Operating Environment

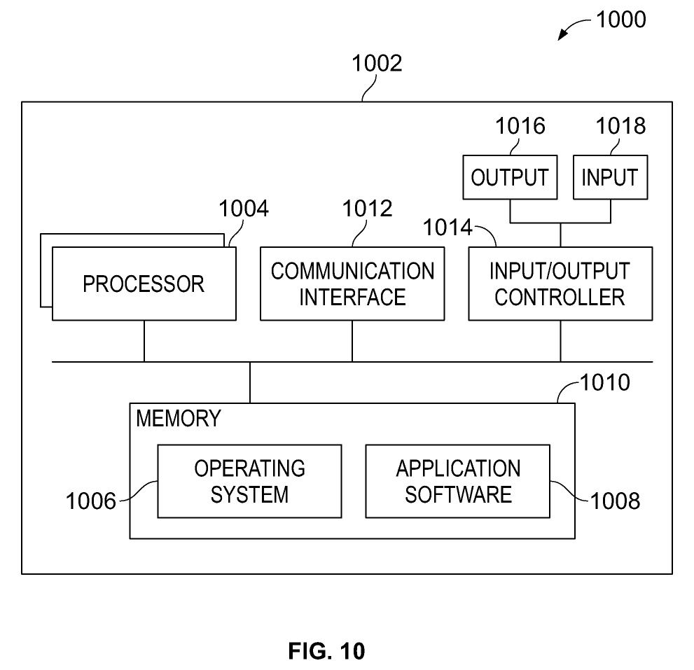

The present disclosure is operable with a computing apparatus according to an implementation as a functional block diagram 1000 in FIG. 10. In an example, components of a computing apparatus 1002 are implemented as a part of circuitry of an electronic device according to one or more implementation described in this specification. The computing apparatus 1002 comprises one or more processors 1004 which may be microprocessors, controllers, or any other suitable type of processors for processing computer executable instructions to control the operation of the electronic device. Alternatively, or in addition, the processor 1004 is any technology capable of executing logic or instructions, such as a hard-coded machine. In some examples, platform software comprising an operating system 1006 and/or any other suitable platform software is provided on the apparatus 1002 to enable application software 908 to be executed on the device.

In some examples, the operations, actions, and/or the like of the systems disclosed herein (e.g., launching mobile platforms, etc.) is accomplished by software, hardware, firmware, and/or the like operating on a single device (e.g., a software module, a processor, a core, a firmware module, and/or the like) or distributed across multiple devices (e.g., one or more software modules, one or more processors, one or more cores, one or more firmware modules, and/or the like). For example, the systems disclosed herein may include a computer storage medium storing instructions that, when executed across two or more processors (and/or across two or more cores of one or more processors), cause the processors (and/or the cores) of the system to collectively perform the operations, actions, and/or the like of the system. For example, one processor of the system could perform one or more of the operations, actions, and/or the like of the system, while another processor could perform one or more other operations, actions, and/or the like of the system.

As used in this application, the term “circuitry” may refer to one or more or all of the following: (a) hardware-only circuit implementations (such as implementations in analog, digital, and/or quantum circuitry); (b) combinations of hardware circuit(s) and software, such as (as applicable): (i) combination of analog, digital, and/or quantum hardware circuit(s) with software/firmware, and (ii) any or all portions of hardware processor(s) (including digital and/or quantum processor(s)) with software, and memory(ies) that work together to cause an apparatus, such as a mobile device, computing device, and/or server, to perform various functions; and (c) any or all portions of hardware circuit(s), such as a microprocessor(s), processor(s), and/or quantum processor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit and/or processor (or multiple processors) and/or portion of a hardware circuit and/or processor and its (and/or their) accompanying software and/or firmware. The term circuitry also covers, for example, and if applicable to the particular claim element, a baseband integrated circuit and/or processor integrated circuit for a mobile device and/or a similar integrated circuit in server, a cellular network device, and/or other computing and/or network device.

In some examples, computer executable instructions are provided using any computer-readable media that is accessible by the computing apparatus 1002. Computer-readable media include, for example, computer storage media and communications media. Computer storage media, such as a memory 1010, include volatile and non-volatile, removable, and non-removable media implemented in any method or technology for storage of information such as computer readable instructions, data structures, program modules, and/or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 1010) is shown within the computing apparatus 1002, it will be appreciated by a person skilled in the art, that, in some examples, the storage is distributed or located remotely and accessed via a network or other communication link (e.g., using a communication interface 1012).

Further, in some examples, the computing apparatus 1002 comprises an input/output controller 1014 configured to output information to one or more output devices 1016, for example a display (e.g., displaying a GUI) or a speaker, which are separate from or integral to the electronic device. Additionally, or alternatively, the input/output controller 1014 is configured to receive and process an input from one or more input devices 1018, for example, a keyboard, a microphone, or a touchpad. In one example, the output device 1016 also acts as the input device. An example of such a device is a touch sensitive display. The input/output controller 1014 may also output data to devices other than the output device, e.g., a locally connected printing device. In some examples, a user provides input to the input device(s) 1018 and/or receives output from the output device(s) 1016.

The functionality described herein can be performed, at least in part, by one or more hardware logic components. According to an implementation, the computing apparatus 1002 is configured by the program code when executed by the processor 1004 to execute the implementations of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an example computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

### Examples

Aspects of the disclosure include an aquatic launching container assembly that includes a stack of at least two mobile platforms and a container. The container includes a body that is configured to be held by an aquatic platform. The body of the container extends a length from a first end to a second end. The body includes an interior compartment that is configured to hold the stack of mobile platforms therein. The first end of the body includes an exit opening. The body is configured to be held by the aquatic platform such that the mobile platforms are configured to be launched from the aquatic platform through the exit opening of the container body.

Optionally, the body of the container includes at least one of a corrosion-resistant material such that the body is configured to be corrosion-resistant, an IP rating of at least one of IP67, IP68, or IP69, or a CTOD score of at least approximately 0.15mm.

Optionally, the body of the container is configured to be held by a deck of the aquatic platform such that the mobile platforms are configured to be launched from the deck of the aquatic platform.

In some examples, the body of the container is configured to be held within a hold of the aquatic platform.

In some examples, the body of the container is configured to be held within a hold of the aquatic platform such that the mobile platforms are configured to be launched from within the hold of the aquatic platform.

In some examples, the body of the container includes a structure of the aquatic platform.

Optionally, the mobile platforms are configured to be launched from within a hold of the aquatic platform through a hatch of the hold.

In some examples, the body of the container is configured to be moved from a hold of the aquatic platform to a deck of the aquatic platform utilizing at least one of a wheel, a track, a cable, a conveyor, or a rail.

Optionally, the container includes a top that includes a closed position and an open position. The top is configured to move from the closed position to the open position to expose the exit opening such that the mobile platforms are configured to be launched from the interior compartment of the container through the exit opening.

In some examples, at least one of the body of the container or the stack of mobile platforms includes a support extending within the interior compartment. The support is configured to engage in physical contact with at least one of a guide element or at least one of the mobile platforms within the interior compartment of the body.

In some examples, the stack of mobile platforms includes guide elements and a support member that interconnects ends of the guide elements.

Optionally, the mobile platforms are configured to be launched from the interior compartment of the container through the exit opening under power of the mobile platforms.

Optionally, the mobile platforms comprise at least one of a UAV, a rotorcraft, or a fixed wing aircraft.

Optionally, the aquatic launching container assembly further includes at least one of a gimbal or a gyroscope configured to hold the container on the aquatic platform such that the at least one of the gimbal or the gyroscope is configured to control an orientation of the container relative to the aquatic platform.

Optionally, a control system is configured to launch the mobile platforms from the container when the container is oriented within an orientation range.

In some examples, the stack of mobile platforms is a first stack of mobile platforms and the interior compartment is configured to hold the first stack of mobile platforms and a second stack of mobile platforms therein. At least one of the first or second stacks of mobile platforms includes at least one of a common base or individual bases that are interconnected together.

Aspects of the disclosure include an aquatic platform that includes a stack of at least two mobile platforms and an enclosure. The enclosure includes an interior compartment that is configured to hold the stack of mobile platforms therein. The enclosure includes a door that includes a closed position and an open position. The door is configured to move from the closed position to the open position to enable the stack of mobile platforms to at least one of exit the interior compartment of the enclosure through the door for launch from a deck of the aquatic platform, or launch through the door from within the interior compartment.

In some examples, the enclosure includes at least one of a corrosion-resistant material, an IP rating of at least one of IP67, IP68, or IP69, or a CTOD score of at least approximately 0.15mm.

Optionally, the interior compartment of the enclosure is an enclosure interior compartment, and the aquatic platform further includes a container that includes a body that is configured to be held within the enclosure interior compartment. The body of the container extends a length from a first end to a second end. The body includes a body interior compartment that is configured to hold the stack of mobile platforms therein. The first end of the body includes an exit opening. The body is configured to be held by the aquatic platform such that the mobile platforms are configured to be launched from the aquatic platform through the exit opening of the container body.

Optionally, the door of the enclosure includes a hatch.

In some examples, the stack of mobile platforms is configured to exit the interior compartment of the enclosure utilizing at least one of a wheel, a track, a conveyor, a cable, or a rail.

Optionally, the aquatic platform further includes at least one of a gimbal or a gyroscope configured to hold the stack of mobile platforms at least one of on the deck or within the interior compartment such that the at least one of the gimbal or the gyroscope is configured to control an orientation of the stack of mobile platforms relative to the aquatic platform.

In some examples, the aquatic platform further includes a control system configured to launch the mobile platforms from the aquatic platform when the stack of mobile platforms is oriented within an orientation range.

In some examples, at least one of the enclosure or the stack of mobile platforms includes a support extending within the interior compartment. The support is configured to engage in physical contact with at least one of a guide element or at least one of the mobile platforms within the interior compartment.

Optionally, the stack of mobile platforms includes guide elements and a support member that interconnects ends of the guide elements.

In some examples, the mobile platforms are configured to be launched from the aquatic platform under power of the mobile platforms.

In some examples, the mobile platforms include at least one of a UAV, a rotorcraft, or a fixed wing aircraft.

In some examples, the aquatic platform includes at least one of a stationary platform or a mobile platform.

Optionally, the stack of mobile platforms is a first stack of mobile platforms and the interior compartment is configured to hold the first stack of mobile platforms and a second stack of mobile platforms therein. At least one of the first or second stacks of mobile platforms includes at least one of a common base or individual bases that are interconnected together.

Aspects of the disclosure include a method that includes installing a stack of at least two mobile platforms on an aquatic platform, and launching the mobile platforms from the aquatic platform while the aquatic platform operates along a body of water.

In some examples, launching the mobile platforms from the aquatic platform includes moving a door of an enclosure of the aquatic platform from a closed position of the door to an open position of the door.

Optionally, launching the mobile platforms from the aquatic platform includes launching the mobile platforms from an interior compartment of an enclosure of aquatic platform.

In some examples, launching the mobile platforms from the aquatic platform includes launching the mobile platforms from an interior compartment of an enclosure of aquatic platform through an exit opening of the interior compartment.

Optionally, launching the mobile platforms from the aquatic platform includes launching the mobile platforms from a deck of the aquatic platform.

In some examples, launching the mobile platforms from the aquatic platform includes launching the mobile platforms from within a container that is held by the aquatic platform.

Optionally, launching the mobile platforms from the aquatic platform includes launching the mobile platforms from within a container that is held on a deck of the aquatic platform.

In some examples, launching the mobile platforms from the aquatic platform includes moving the stack of mobile platforms from an enclosure of the aquatic platform to a deck of the aquatic platform.

Optionally, launching the mobile platforms from the aquatic platform includes moving a container that holds the stack of mobile platforms from an enclosure of the aquatic platform to a deck of the aquatic platform.

In some examples, launching the mobile platforms from the aquatic platform includes moving the stack of mobile platforms along at least one of a rail, a wheel, a cable, a conveyor, or a track.

Optionally, launching the mobile platforms from the aquatic platform includes at least one of flying the mobile platforms, launching the mobile platforms under power of the mobile platforms, or propelling the mobile platforms.

In some examples, launching the mobile platforms from the aquatic platform includes at least one of: at least one of automatically or remotely opening at least one of a door of aquatic platform or a top of a container; or manually opening at least one of the door or the top.

Optionally, launching the mobile platforms from the aquatic platform includes at least one of controlling or changing an orientation of the stack of mobile platforms relative to the aquatic platform.

In some examples, launching the mobile platforms from the aquatic platform includes launching the mobile platforms when an orientation of the aquatic platform is within an orientation range.

Optionally, launching the mobile platforms from the aquatic platform includes launching the mobile platforms when at least one of a pitch or a roll of the aquatic platform is within a range that includes an approximately horizontal orientation.

In some examples, launching the mobile platforms from the aquatic platform includes launching the mobile platforms based on at least one of an environmental condition, a water roughness, or a safe condition.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms "comprising," "including," and "having" are intended to be inclusive and mean that there can be additional elements other than the listed elements. In other words, the use of "including," "comprising," "having," "containing," "involving," and variations thereof, is meant to encompass the items listed thereafter and additional items. Accordingly, and for example, unless explicitly stated to the contrary, implementations "comprising" or "having" an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles "a," "an," "the," and "said" are intended to mean that there are one or more of the elements. In other words, the indefinite articles "a", “an”, “the”, and “said” as used in the specification and in the claims, unless clearly indicated to the contrary, should be understood to mean "at least one." Accordingly, and for example, as used herein, an element or step recited in the singular and preceded by the word "a" or "an" should be understood as not necessarily excluding the plural of the elements or steps.

The phrase “one or more of the following: A, B, and C” means “at least one of A and/or at least one of B and/or at least one of C." The phrase "and/or", as used in the specification and in the claims, should be understood to mean "either or both" of the elements so conjoined, i.e., elements that are conjunctively present in some cases and disjunctively present in other cases. Multiple elements listed with "and/or" should be construed in the same fashion, i.e., "one or more" of the elements so conjoined. Other elements may optionally be present other than the elements specifically identified by the "and/or" clause, whether related or unrelated to those elements specifically identified. Thus, as a non-limiting example, a reference to "A and/or B", when used in conjunction with open-ended language such as "comprising" can refer, in one implementation, to A only (optionally including elements other than B); in another implementation, to B only (optionally including elements other than A); in yet another implementation, to both A and B (optionally including other elements); etc.

As used in the specification and in the claims, "or" should be understood to have the same meaning as "and/or" as defined above. For example, when separating items in a list, "or" or "and/or" shall be interpreted as being inclusive, i.e., the inclusion of at least one, but also including more than one, of a number or list of elements, and, optionally, additional unlisted items. Only terms clearly indicated to the contrary, such as "only one of or "exactly one of," or, when used in the claims, "consisting of," will refer to the inclusion of exactly one element of a number or list of elements. In general, the term "or" as used shall only be interpreted as indicating exclusive alternatives (i.e., "one or the other but not both") when preceded by terms of exclusivity, such as "either," "one of' "only one of' or "exactly one of." "Consisting essentially of," when used in the claims, shall have its ordinary meaning as used in the field of patent law.

As used in the specification and in the claims, the phrase "at least one," in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase "at least one" refers, whether related or unrelated to those elements specifically identified. Thus, as a non-limiting example, "at least one of A and B" (or, equivalently, "at least one of A or B," or, equivalently "at least one of A and/or B") can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as "first," "second," "third," etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms "including" and "in which" are used as the plain-English equivalents of the respective terms "comprising" and "wherein." Moreover, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The

patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An aquatic launching container assembly comprising:
a stack of at least two mobile platforms; and
a container comprising a body that is configured to be held by an aquatic platform, the body of the container extending a length from a first end to a second end, the body comprising an interior compartment that is configured to hold the stack of mobile platforms therein, the first end of the body comprising an exit opening, wherein the body is configured to be held by the aquatic platform such that the mobile platforms are configured to be launched from the aquatic platform through the exit opening of the body.

2. The aquatic launching container assembly of claim 1, wherein the body of the container comprises at least one of:
a corrosion-resistant material such that the body is configured to be corrosion-resistant;
an ingress protection (IP) rating of at least one of IP67, IP68, or IP69;
a crack tip opening displacement (CTOD) score of at least approximately 0.15mm; or
a structure of the aquatic platform.

3. The aquatic launching container assembly of claim 1, wherein the body of the container is configured to be held at least one of:
by a deck of the aquatic platform such that the mobile platforms are configured to be launched from the deck of the aquatic platform;
within a hold of the aquatic platform such that the mobile platforms are configured to be launched from within the hold of the aquatic platform; or
within the hold of the aquatic platform such that the mobile platforms are configured to be launched from within the hold through a hatch of the hold.

4. The aquatic launching container assembly of claim 1, wherein the body of the container is configured to be held within a hold of the aquatic platform.

5. The aquatic launching container assembly of claim 1, wherein the body of the container is configured to be moved from a hold of the aquatic platform to a deck of the aquatic platform utilizing at least one of a wheel, a track, a cable, a conveyor, or a rail.

6. The aquatic launching container assembly of claim 1, wherein the container comprises a top that includes a closed position and an open position, wherein the top is configured to move from the closed position to the open position to expose the exit opening such that the mobile platforms are configured to be launched from the interior compartment of the container through the exit opening.

7. The aquatic launching container assembly of claim 1, wherein at least one of the body of the container or the stack of mobile platforms comprises at least one of:
a support extending within the interior compartment, wherein the support is configured to engage in physical contact with at least one of a guide element or at least one of the mobile platforms within the interior compartment of the body; or
guide elements and a support member that interconnects ends of the guide elements.

8. The aquatic launching container assembly of claim 1, wherein the mobile platforms at least one of:
comprise at least one of an uncrewed aerial vehicle (UAV), a rotorcraft, or a fixed wing aircraft; or
are configured to be launched from the interior compartment of the container through the exit opening under power of the mobile platforms.

9. An aquatic platform comprising:
a stack of at least two mobile platforms; and
an enclosure comprising an interior compartment configured to hold the stack of mobile platforms therein, the enclosure comprising a door that includes a closed position and an open position, wherein the door is configured to move from the closed position to the open position to enable the stack of mobile platforms to at least one of:
exit the interior compartment of the enclosure through the door for launch from a deck of the aquatic platform; or
launch through the door from within the interior compartment.

10. The aquatic platform of claim 9, wherein the enclosure comprises at least one of:
a corrosion-resistant material;
an IP rating of at least one of IP67, IP68, or IP69; or
a CTOD score of at least approximately 0.15mm.

11. The aquatic platform of claim 9, wherein the interior compartment of the enclosure is an enclosure interior compartment, the aquatic platform further comprising a container comprising a body that is configured to be held within the enclosure interior compartment, the body of the container extending a length from a first end to a second end, the body comprising a body interior compartment that is configured to hold the stack of mobile platforms therein, the first end of the body comprising an exit opening, wherein the body is configured to be held by the aquatic platform such that the mobile platforms are configured to be launched from the aquatic platform through the exit opening of the body.

12. The aquatic platform of claim 9, wherein the door of the enclosure comprises a hatch.

13. The aquatic platform of claim 9, wherein the stack of mobile platforms is configured to exit the interior compartment of the enclosure utilizing at least one of a wheel, a track, a cable, a conveyor, or a rail.

14. The aquatic platform of claim 9, further comprising at least one of a gimbal or a gyroscope configured to hold the stack of mobile platforms at least one of on the deck or within the interior compartment such that the at least one of the gimbal or the gyroscope is configured to control an orientation of the stack of mobile platforms relative to the aquatic platform.

15. The aquatic platform of claim 9, further comprising a control system configured to launch the mobile platforms from the aquatic platform when the stack of mobile platforms is oriented within an orientation range.

16. The aquatic platform of claim 9, wherein the stack of mobile platforms comprises guide elements and a support member that interconnects ends of the guide elements.

17. The aquatic platform of claim 9, wherein the aquatic platform comprises at least one of a stationary platform or a mobile platform.

18. The aquatic platform of claim 9, wherein the stack of mobile platforms is a first stack of mobile platforms and the interior compartment is configured to hold the first stack of mobile platforms and a second stack of mobile platforms therein, wherein at least one of the first or second stacks of mobile platforms comprises at least one of a common base or individual bases that are interconnected together.

19. A method comprising:
installing a stack of at least two mobile platforms on an aquatic platform; and
launching the mobile platforms from the aquatic platform while the aquatic platform operates along a body of water.

20. The method of claim 19, wherein launching the mobile platforms from the aquatic platform comprises at least one of:
moving a door of an enclosure of the aquatic platform from a closed position of the door to an open position of the door;
launching the mobile platforms from an interior compartment of the enclosure of aquatic platform;
launching the mobile platforms from the interior compartment of the enclosure through an exit opening of the interior compartment;
launching the mobile platforms from a deck of the aquatic platform;
launching the mobile platforms from within a container that is held by the aquatic platform;
launching the mobile platforms from within a container that is held on a deck of the aquatic platform;
moving the stack of mobile platforms from the enclosure of the aquatic platform to the deck of the aquatic platform;
moving the container from the enclosure of the aquatic platform to the deck of the aquatic platform;
moving the stack of mobile platforms along at least one of a rail, a wheel, a cable, a conveyor, or a track;
flying the mobile platforms;
launching the mobile platforms under power of the mobile platforms;
propelling the mobile platforms;
at least one of automatically or remotely opening at least one of a door of aquatic platform or a top of a container;
manually opening at least one of the door or the top;
at least one of controlling or changing an orientation of the stack of mobile platforms relative to the aquatic platform;
launching the mobile platforms when an orientation of the aquatic platform is within an orientation range;
launching the mobile platforms when at least one of a pitch or a roll of the aquatic platform is within a range that includes an approximately horizontal orientation; or
launching the mobile platforms based on at least one of an environmental condition, a water roughness, or a safe condition.
